(19) United States
(12) Patent Application Publication
(10) Pub. No.: US 2016/0297412 A1
(43) Pub. Date: Oct. 13, 2016

(54) METHOD FOR CONTROLLING ADVANCED EMERGENCY BRAKING SYSTEM DEPENDING ON LOAD CHANGE OF VEHICLE

(71) Applicant: HYUNDAI MOTOR COMPANY, Seoul (KR)

(72) Inventor: Hong Gi PARK, Seoul (KR)

(21) Appl. No.: 14/923,287

(22) Filed: Oct. 26, 2015

(30) Foreign Application Priority Data
Apr. 9, 2015 (KR) 10-2015-0050396

(51) Int. Cl. B60T 8/18; B60T 7/22

(52) U.S. Cl. CPC B60T 8/1837; B60T 7/22

(57) ABSTRACT

A method for controlling an automatic emergency braking system is able to optimize a control of the automatic emergency braking system depending on a load of a vehicle by classifying the load of the vehicle into load groups depending on the load of the vehicle and by controlling control factors including a braking command point in time corresponding to a time to collision (TTC) and a deceleration depending on the load groups. The method for controlling an advanced emergency braking system depending on a load change of a vehicle includes: calculating a load of the vehicle by receiving braking information from an engine controller; classifying the calculated load of the vehicle into a load group among a plurality of load groups; and controlling a control factor of the advanced emergency braking system depending on the classified load group.

### CROSS-REFERENCE TO RELATED APPLICATION

This application is based on and claims the benefit of priority to Korean Patent Application No. 10-2015-0050396, filed on Apr. 9, 2015 in the Korean Intellectual Property Office, the disclosure of which is incorporated herein in its entirety by reference.

### TECHNICAL FIELD

The present disclosure relates to a method for controlling an advanced emergency braking system depending on a load change of a vehicle, and more particularly, to a technology capable of minimizing an influence of a load in an advanced emergency braking system by controlling a braking control factor depending on the load of a vehicle.

### BACKGROUND

Generally, a vehicle is provided with a braking device serving to decelerate or stop the vehicle during being driven.

The braking device is configured to include a booster doubling a foot effort of a brake pedal using vacuum pressure (engine suction pressure) generated by power of an engine, a master cylinder generating brake oil pressure in a brake circuit depending on the pressure doubled by the booster, and a wheel cylinder decreasing a rotation speed of a wheel or stopping the wheel by the brake oil pressure. Here, the booster is generally classified into a vacuum type booster using negative pressure of an engine intake manifold and an air type boost using pressure provided from a compressor driven by the engine.

Since the braking device starts the braking of the vehicle after a driver performs an operation of stepping on the brake pedal regardless of a configuration of the braking device, there is a limitation in a viewpoint of the driver having a limitation in a reaction time.

An automatic emergency brake system (AEBS) to complement this limitation includes a radar to activate emergency braking regardless of whether or not the driver performs braking based on a relative speed and a spaced distance to an object, determined by the radar, in the case in which the object appears in front of the vehicle that is being driven.

The AEBS has system performance determined depending on various driving conditions and is set so as to correspond to the most general driving condition.

### SUMMARY

The present disclosure has been made to solve the above-mentioned problems occurring in the prior art while advantages achieved by the prior art are maintained intact.

An aspect of the present disclosure provides a method for controlling an automatic emergency braking system capable of optimizing a control of the automatic emergency braking system depending on a load of a vehicle by classifying the load of the vehicle into load groups depending on the load of the vehicle and controlling control factors including a braking command point in time corresponding to a time to collision (TTC) and a deceleration depending on the load groups.

Objects of the present disclosure are not limited to the above-mentioned object, and other objects and advantages of the present disclosure that are not mentioned may be understood by the following description and will be more clearly appreciated by exemplary embodiments of the present disclosure. In addition, it may be easily appreciated that objects and advantages of the present disclosure may be realized by means mentioned in the claims and a combination thereof.

According to an exemplary embodiment of the present disclosure, a method for controlling an advanced emergency braking system depending on a load change of a vehicle includes: calculating a load of the vehicle by receiving braking information from an engine controller; classifying the calculated load of the vehicle into a load group among a plurality of load groups; and controlling a control factor of the advanced emergency braking system depending on the classified load group.

The braking information may include a revolution per minute (RPM) of the vehicle, an engine torque, or an acceleration of the vehicle.

The plurality of load groups may include a first group, a second group, and a third group, and the control factors of the advanced emergency braking system corresponding to the plurality of load groups may be different from one another.

The controlling of the control factor of the advanced emergency braking system may include controlling a braking command point in time corresponding to a time to collision and a deceleration.

In a process of controlling the control factor of the advanced emergency braking system depending on the first group, the braking command point in time corresponding to the time to collision and the deceleration may be controlled to be preset values.

In a process of controlling the control factor of the advanced emergency braking system depending on the second group, the braking command point in time corresponding to the time to collision and the deceleration may be controlled to be decreased as compared with the braking command point in time and the deceleration in the first group.

In a process of controlling the control factor of the advanced emergency braking system depending on the third group, the braking command point in time corresponding to the time to collision and the deceleration may be controlled to be decreased as compared with the braking command point in time and the deceleration in the second group.

According to an exemplary embodiment of the present disclosure, a method for controlling an advanced emergency braking system depending on a load change of a vehicle, includes: calculating a load of the vehicle based on braking information from an engine controller; determining a control factor of the advanced emergency braking system based on the calculated load of the vehicle; and controlling the advanced emergency braking system in accordance with the determined control factor.

The control factor may include a braking command point in time corresponding to a time to collision and a deceleration.

### BRIEF DESCRIPTION OF THE DRAWINGS

The above and other objects, features and advantages of the present disclosure will be more apparent from the following detailed description taken in conjunction with the accompanying drawings.

FIG. 1 is a flow chart for describing a method for controlling an advanced emergency braking system depending on a load change of a vehicle according to an exemplary embodiment of the present disclosure.

FIG. 2 is a view for describing a distance secured from a front vehicle or a preceding vehicle after emergency braking depending on a control factor for each load group of the advanced emergency braking system according to the exemplary embodiment of the present disclosure.

FIG. 3 is a graph for describing a braking command point in time corresponding to a time to collision (TTC) and a distance secured from a front vehicle or a preceding vehicle after emergency braking in the advanced emergency braking system depending on a load change of a vehicle according to the exemplary embodiment of the present disclosure.

FIG. 4 is a graph for describing a load of a vehicle and a distance secured from a front vehicle or a preceding vehicle after emergency braking in the advanced emergency braking system depending on a load change of a vehicle according to the exemplary embodiment of the present disclosure.

### DETAILED DESCRIPTION

The above-mentioned objects, features, and advantages will become more obvious from the following description described below in detail with reference to the accompanying drawings. Therefore, those skilled in the art to which the present disclosure pertains may easily practice a technical idea of the present disclosure. Further, in describing the present disclosure, in the case in which it is judged that a detailed description of a well-known technology associated with the present disclosure may unnecessarily make the gist of the present disclosure unclear, it will be omitted. Hereinafter, exemplary embodiments of the present disclosure will be described in detail with reference to the accompanying drawings.

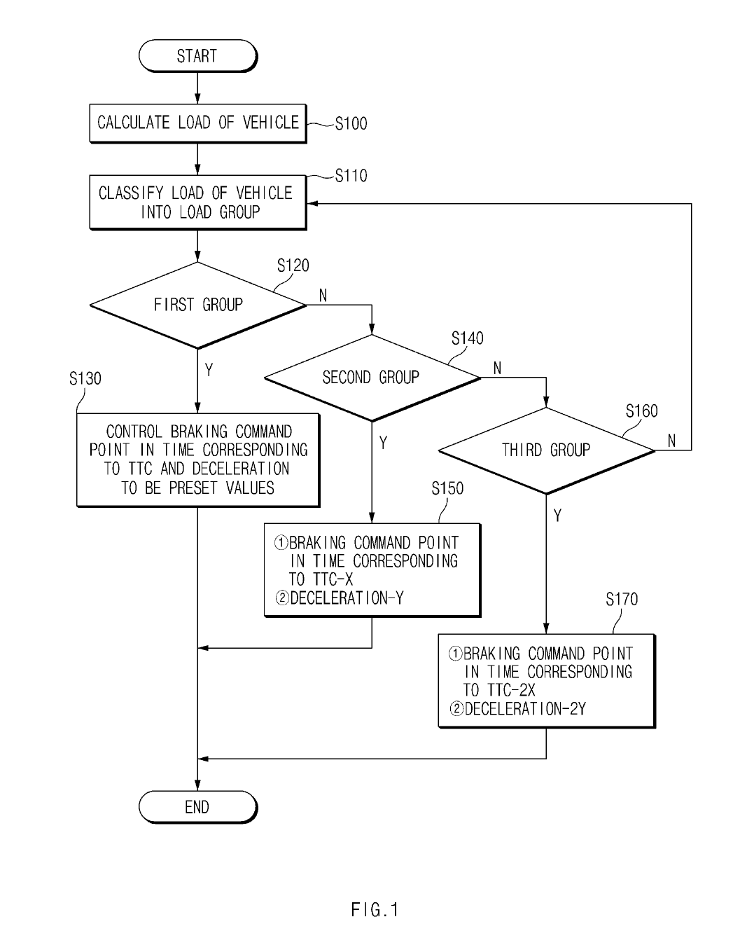

FIG. 1 is a flow chart for describing a method for controlling an advanced emergency braking system depending on a load change of a vehicle according to an exemplary embodiment of the present disclosure.

Referring to FIG. 1, a controller of the advanced emergency braking system calculates a load of a vehicle using a revolution per minute (RPM) of the vehicle, an engine torque, an acceleration of the vehicle, or the like, received from an engine control unit (ECU) (S100).

Here, the load or a weight of the vehicle may be calculated by dividing a value obtained by subtracting a friction torque from an engine output torque transmitted from an engine by a dynamic load radius and dividing an output value of the division by an acceleration value in a longitudinal direction measured from an acceleration sensor.

In addition, since the controller of the advanced emergency braking system, which is a requisite component, is a general component according to the related art, a detailed description therefor will be omitted.

Next, the controller of the advanced emergency braking system classifies the calculated load of the vehicle into each load group (S110).

In detail, depending on the load of the vehicle, a group (that is, a loaded group) of vehicles having the largest load is defined as a first group (S120), a group (that is, a partial loaded group) of vehicles having a medium load is defined as a second group (S140), and a group (that is, an unloaded group) of vehicles having the smallest load is defined as a third group (S160). That is, the group of the vehicles having the largest load means vehicles having a maximum load among loads preset in the advanced emergency braking system, and the group of the vehicles having the smallest load means vehicles having a minimum load among the loads preset in the advanced emergency braking system. According to another embodiment of the present disclosure, the load of the vehicle may be classified into two load groups or four or more load groups. Here, the vehicle means vehicle in which only a weight of a vehicle body and a weight of a driver are present except for a weight of an article loaded in the vehicle.

For example, it may be assumed that a weight of the vehicle in the group of the vehicles having the largest load is 6 tons, which is the sum of a weight of the vehicle and a weight of a person getting in the vehicle or an article loaded in the vehicle, it may be assumed that a weight of the vehicle in the group of the vehicles having the medium load is 4.5 tons, which is the sum of a weight of the vehicle and a weight of a person getting in the vehicle or an article loaded in the vehicle, and it may be assumed that a weight of the vehicle in the group of the vehicles having the smallest load is 3 tons, which is the sum of a weight of the vehicle and a weight of a person getting in the vehicle or an article loaded in the vehicle. Here, set ranges of loads or weights of the vehicles corresponding to each group may be controlled by of the controller of the advanced emergency braking system.

Next, when the load group of the vehicles, determined by the controller, has the largest load (first group) (S120), the controller of the advanced emergency braking system of the vehicle controls a braking command point in time (time) corresponding to a time to collision (TTC) and a deceleration (g) among control factors for controlling braking of the vehicle to be preset values (S130). Here, when advanced emergency braking of the vehicle is first controlled to classify the load of the vehicle into the load group, a control factor for controlling the braking of the vehicle may be controlled in a state in which the load of the vehicle is set to the group of the vehicles having the largest load. In the case of the group of the vehicles having the largest load, a distance secured between an own vehicle and a front vehicle or a preceding vehicle is not changed from a preset secured distance.

Next, when the load group of the vehicles, determined by the controller, has the medium load (second group) (S140), the controller of the advanced emergency braking system may decrease a braking command point in time corresponding to a time to collision and a deceleration among the control factors for controlling the braking of the vehicle as compared with the braking command point in time corresponding to the time to collision and the deceleration in the group of the vehicles having the largest load (S150).

In detail, in case of the group of the vehicles having the medium load, the controller of the advanced emergency braking system may decrease the braking command point in time corresponding to the time to collision by X and decrease the deceleration by Y.

For example, the controller of the advanced emergency braking system may decrease the braking command point in time corresponding to the time to collision by 0.1 s and decrease the deceleration by 1 m/s². Here, the controller of the advanced emergency braking system may variously control a decrease amount of the braking command point in time corresponding to the time to collision and a decrease amount of the deceleration.

Next, when the load group of the vehicles, determined by the controller, has the smallest load (third group) (S160), the controller of the advanced emergency braking system may further decrease a braking command point in time corresponding to a time to collision and a deceleration among the control factors for controlling the braking of the vehicle as compared with the braking command point in time corresponding to the time to collision and the deceleration in the group of the vehicles having the medium load (S170).

In detail, in case of the group of the vehicles having the smallest load, the controller of the advanced emergency braking system may decrease the braking command point in time corresponding to the time to collision by 2X and decrease the deceleration by 2Y. For example, the controller of the advanced emergency braking system may decrease the braking command point in time corresponding to the time to collision by 0.2 s and decrease the deceleration by 2 m/s². Here, the controller of the advanced emergency braking system may variously control a decrease amount of the braking command point in time corresponding to the time to collision and a decrease amount of the deceleration.

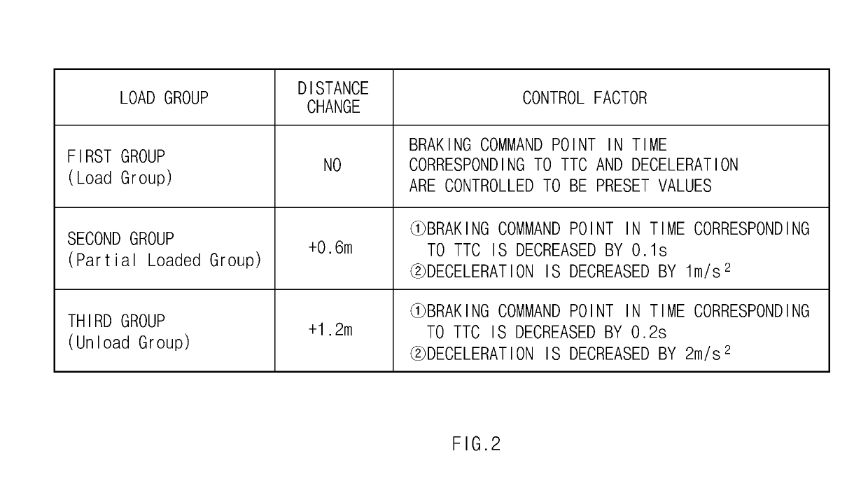

FIG. 2 is a view for describing a distance secured from a front vehicle or a preceding vehicle after emergency braking depending on a control factor for each load group of the advanced emergency braking system depending on a load change of a vehicle according to the exemplary embodiment of the present disclosure.

Referring to FIG. 2, in the case of the group of the vehicles having the largest load, the controller of the advanced emergency braking system controls the braking command point in time corresponding to the time to collision and the deceleration among the control factors for controlling the braking of the vehicle to be the preset values.

In addition, in the case of the group of the vehicles having the largest load, a distance secured between an own vehicle and a front vehicle or a preceding vehicle after emergency braking is not changed from a preset braking distance.

In the case of the group of the vehicles having the medium load, the controller of the advanced emergency braking system may decrease the braking command point in time corresponding to the time to collision and the deceleration among the control factors for controlling the braking of the vehicle as compared with the braking command point in time corresponding to the time to collision and the deceleration in the group of the vehicles having the largest load.

That is, in the case of the group of the vehicles having the medium load, when the control factors for controlling the braking of the vehicle are not controlled by the controller, a distance secured from a front vehicle or a preceding vehicle after emergency braking is further increased from a preset braking distance by Z. For example, the distance Z secured from the front vehicle or the preceding vehicle after the emergency braking may be further increased by 0.6 m. Therefore, after the emergency braking, the own vehicle may be controlled so that the distance secured between the own vehicle and the front vehicle is the same as in the case of the group of the vehicles having the largest load using the control factors for controlling the braking of the vehicle by the increased distance to the front vehicle.

In the case of the group of the vehicles having the smallest load, the controller of the advanced emergency braking system may further decrease the braking command point in time corresponding to the time to collision and the deceleration among the control factors for controlling the braking of the vehicle as compared with the braking command point in time corresponding to the time to collision and the deceleration in the group of the vehicles having the middle load.

In addition, in the case of the group of the vehicles having the smallest load, a distance secured from a front vehicle or a preceding vehicle after emergency braking is further increased by 2Z as compared with the distance secured from the front vehicle or the preceding vehicle after the emergency braking in the case of the group of the vehicles having the medium load. For example, the distance 2Z secured from the front vehicle or the preceding vehicle after the emergency braking may be further increased by 1.2 m. Therefore, after the emergency braking, the own vehicle may be controlled so that the distance secured between the own vehicle and the front vehicle is the same as in the case of the group of the vehicles having the medium load using the control factors for controlling the braking of the vehicle by the increased distance to the front vehicle.

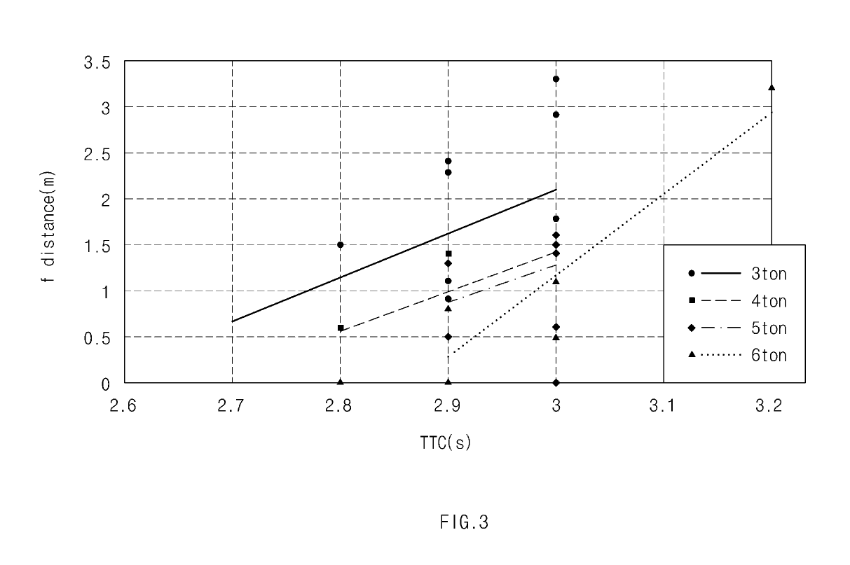

FIG. 3 is a graph for describing a braking command point in time corresponding to a time to collision (TTC) and a distance secured from a front vehicle or a preceding vehicle after emergency braking in the advanced emergency braking system according to the exemplary embodiment of the present disclosure.

Referring to FIG. 3, as a result of comparison between the braking command point in time corresponding to the time to collision and the distance secured between the own vehicle and the front vehicle or the preceding vehicle depending on the load of the vehicle, the distance secured between the own vehicle and the front vehicle is increased as the braking command point in time corresponding to the time to collision becomes fast.

In addition, the controller of the advanced emergency braking system may instruct the braking command point in time corresponding to the time to collision to become fast as the load of the vehicle is increased.

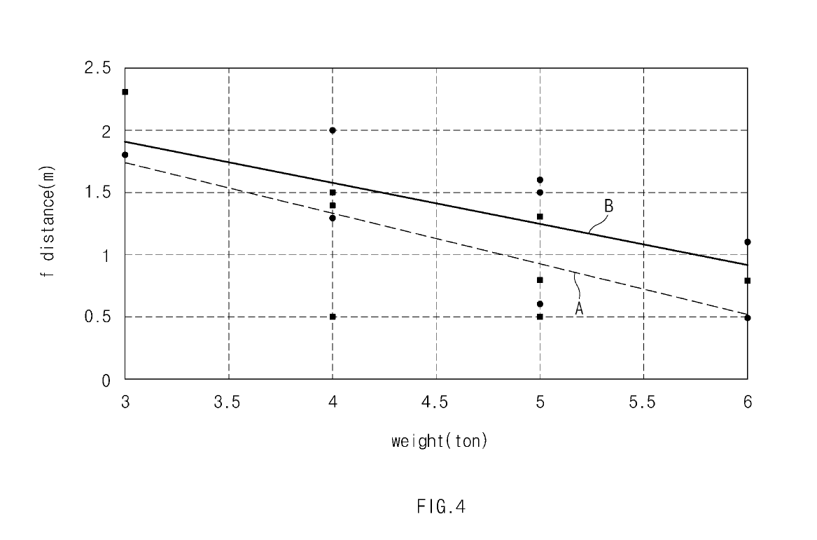

FIG. 4 is a graph for describing a load of a vehicle and a distance secured from a front vehicle or a preceding vehicle after emergency braking in the advanced emergency braking system depending on a load change of a vehicle according to the exemplary embodiment of the present disclosure.

Referring to FIG. 4, it is illustrated that the distance secured between the own vehicle and the front vehicle is increased as the load of the vehicle is decreased. That is, it may be appreciated that the distance secured between the own vehicle and the front vehicle or the preceding vehicle is increased as the load of the vehicle is decreased in both of groups A and B of different kinds of vehicles.

As described above, the present technology is a technology capable of minimizing an influence depending on the load of the vehicle in the advanced emergency braking system depending on a load change of a vehicle according to the exemplary embodiment at the time of the emergency braking.

In addition, the present technology is a technology capable of preventing unnecessary braking generated depending on the load of the vehicle and controlling the control factors depending on the load of the vehicle at the time of the emergency braking for each load group, thereby optimizing a control of the advanced emergency braking system.

Hereinabove, although the present disclosure has been described with reference to restrictive configurations and the accompanying drawings, the present disclosure is not limited thereto, but may be variously modified and altered by those skilled in the art to which the present disclosure pertains without departing from the spirit of the present disclosure and equivalents to the following claims.

What is claimed is:

1. A method for controlling an advanced emergency braking system depending on a load change of a vehicle, comprising:
calculating a load of the vehicle by receiving braking information from an engine controller;
classifying the calculated load of the vehicle into a load group among a plurality of load groups; and
controlling a control factor of the advanced emergency braking system depending on the classified load group.

2. The method according to claim 1, wherein the braking information includes a revolution per minute (RPM) of the vehicle, an engine torque, or an acceleration of the vehicle.

3. The method according to claim 1, wherein the plurality of load groups include a first group, a second group, and a third group, and the control factors of the advanced emergency braking system corresponding to the plurality of load groups are different from one another.

4. The method according to claim 3, wherein the controlling of the control factor of the advanced emergency braking system includes controlling a braking command point in time corresponding to a time to collision and a deceleration.

5. The method according to claim 4, wherein in a process of controlling the control factor of the advanced emergency braking system depending on the first group, the braking command point in time corresponding to the time to collision and the deceleration are controlled to be preset values.

6. The method according to claim 4, wherein in a process of controlling the control factor of the advanced emergency braking system depending on the second group, the braking command point in time corresponding to the time to collision and the deceleration are controlled to be decreased as compared with the braking command point in time and the deceleration in the first group.

7. The method according to claim 4, wherein in a process of controlling the control factor of the advanced emergency braking system depending on the third group, the braking command point in time corresponding to the time to collision and the deceleration are controlled to be decreased as compared with the braking command point in time and the deceleration in the second group.

8. A method for controlling an advanced emergency braking system depending on a load change of a vehicle, comprising:
calculating a load of the vehicle based on braking information from an engine controller;
determining a control factor of the advanced emergency braking system based on the calculated load of the vehicle; and
controlling the advanced emergency braking system in accordance with the determined control factor.

9. The method according to claim 8, wherein the control factor includes a braking command point in time corresponding to a time to collision and a deceleration.
